(19) United States
(12) Patent Application Publication
(10) Pub. No.: US 2001/0037933 A1
(43) Pub. Date: Nov. 8, 2001

(54) Illuminated membrane switch

(76) Inventors: Richard Stuart Hunter, Christchurch (NZ); John Kenneth Tucker, Christchurch (NZ)

Correspondence Address: JACOBSON HOLMAN PLLC, 400 SEVENTH STREET N.W., SUITE 600, WASHINGTON, DC, 20004, US

(21) Appl. No.: 09/906,853

(22) Filed: Jul. 18, 2001

Related U.S. Application Data
(63) Continuation-in-part of application No. 09/331,345, filed on Jun. 17, 1999, now abandoned.

(51) Int. Cl. H01H 9/00; H01H 13/702

(52) U.S. Cl. 200/310; 200/314; 200/317; 200/512

(57) ABSTRACT

An electroluminescent switch is described incorporating an electroluminescent lamp assembly and one or more membrane switch assembly. The rear or base electrode of the electroluminescent lamp and a conductive layer of the membrane switch are superimposed on opposite sides of the same element which functions as the means by which the membrane switch may be closed upon actuation by a user. The membrane switch can be constructed from two electrodes arranged so that the conductive layer when brought into contact with said electrodes, shorts the electrodes thereby closing the circuit. Applications for the membrane switch include electronic devices where panel switches are required or electronic devices requiring particularly thin switches which are to be backlit.

### FIELD OF THE INVENTION

The present invention is a continuation-in-part of U.S. patent application Ser. No. 09/331,345 and relates to combined lamp/membrane switch assemblies. More particularly, although not exclusively, the present invention relates to a membrane switch and electroluminescent lamp panel combined to form a discrete unit in which a number of components serve functions relating to the operation of both switch and lamp.

### BACKGROUND TO THE INVENTION

Membrane switches are well known in the art and generally refer to electrical switches constructed from at least two layers of plastic, or similar, film facing each other wherein one film carries at least two electrodes and the other is adapted to short the electrodes when the two films are pressed together. In a common embodiment, one of the faces of the plastic film carries an array of conducting tracks. The array corresponds essentially to two electrodes which, when shorted, complete the circuit. Such an electrode array is usually formed in a pattern of interlocking, “finger-like”, tracks. This increases the likelihood that if a conductor is brought into contact with the surface the electrodes are shorted.

The surface of the plastic film facing this array of conductive tracks is either coated with a conductive material or the plastic film may be substituted with a conducting layer. A spacer element is interposed between the two opposing plastic surfaces. The spacer element has dimensions and geometry so that when pressure is applied to the membrane switch, the juxtaposed conductive layer and electrode array are brought together, whereupon the conductive layer shorts at least two of the electrode connections thereby completing the circuit and closing the switch.

The spacer layer may be formed from a paper, card layer or a die cut plastic film layer having an aperture or apertures located between the contacts of the electrode array on the surface of one of the films and the conducting layer on the opposing surface of the opposite film.

Such membrane switches are usually manufactured by laminating the respective layers onto substrate surfaces.

Electroluminescent (hereinafter referred to as EL) devices, as known in the art, can broadly be described as a capacitive device wherein a planar base electrode is separated from a planar transparent electrode by a phosphorescent or the like layer with a dielectric layer interposed between the two planar electrodes. When an AC voltage is applied across the conductive electrodes (i-e the capacitive plates), the current induced between the base and the transparent electrode causes the phosphor or the like layer to emit light. The light is visible through the transparent electrode. A variety of phosphorescent layer compositions can be used to provide various colours. Alternatively, or in combination, the transparent electrode itself may be coloured.

EL devices are advantageous in that they are relatively thin and may be manufactured by mass production lamination and/or printing techniques. EL devices are particularly adapted to switch arrays for use on panels or instruments which would normally be required to be backlit by some type of lamp and focusing assembly which projects light onto a translucent layer. This is intended to give the impression of a lit panel. The use of an EL device dispenses with the need for a physical (usually incandescent) lamp, focusing or light dispersion device and the hardware associated therewith. Accordingly, EL devices are particularly suitable for applications where there is little or no room available for back lit physical switches or in similar applications where flat switch arrays are required.

Unless a membrane switch incorporates a tactile feedback component, such as a “clicking device” embedded in the switch assembly itself, a user is generally provided with no indication as to whether the switch has been actuated or not. Other means of providing such feedback include providing an LED which illuminates when the switch contact is closed or a backlit membrane switch which itself is illuminated upon the switch being closed. EL devices are particularly suitable for combination with membrane switches and a number of prior art documents have addressed these applications. The reader is referred to U.S. Pat. No. 4,683,360 and U.S. Pat. No. 4,060,703 for a useful discussion. The latter case describes essentially a discrete continuously lit EL lamp embedded in a “bubble” type membrane switch.

When used in situations such as panel switches or flat array instruments, it is desirable that the lamp/switch device be as thin as practicable A number of prior art devices have attempted to address this problem by mounting a membrane switch next to a flat EL lamp. Such constructions, while being useful, are not particularly well suited to situations where the switch itself is required to be illuminate upon actuation or where shapes, patterns or letters are to be illuminated in response to touching or pressing the general area corresponding to that shape or pattern.

Accordingly, it is an object of the present invention to overcome some of the above-mentioned difficulties and to provide a combination EL lamp and membrane switch which is thin, adaptable to manufacture and is particularly suitable for flat array or panel switch assemblies. It is a further object of the invention to provide an attractive and compact lamp/switch assembly or to at least provide the public with a useful choice.

### DISCLOSURE OF THE INVENTION

In one aspect the invention provides for an electroluminescent device and membrane switch including:

one or more electroluminescent lamp assemblies and one or more membrane switch assemblies, wherein a rear flexible electrode of the electroluminescent device and a conductive layer of the membrane switch are superimposed on opposite sides of the same element which functions as the means by which the membrane switch is closed upon actuation by a user.

Preferably the electroluminescent lamp/membrane switch assembly comprises:

a membrane switch including:

at least two electrodes arranged so that upon bringing a flexible conductive layer in contact with said electrodes, the electrodes are shorted;

a flexible conductive layer covering at least two of the electrodes;

a spacer interposed between the conductive layer and the at least two electrodes, the spacer being adapted to hold the conductive layer away from the at least two electrodes while allowing the conductive layer to come into contact with the at least two electrodes upon the application of pressure by a user;

an electroluminescent lamp comprising:

a rear electrode;

a substrate layer juxtaposed over the rear electrode wherein a phosphor layer and dielectric layer are interposed between the rear electrode and a substrate layer;

wherein the rear electrode of the electroluminescent lamp and the conductive layer of the membrane switch are superimposed on opposite sides of the same element.

Preferably the at least two electrodes are in the form of a conductive array deposited on a switch substrate layer wherein the conductive array is adapted so that when the conductive layer is pressed thereupon, the at least two electrodes are shorted.

Preferably the at least two electrodes are in the form of an array of intermeshed tracks formed on the switch substrate.

Preferably the dielectric layer is superimposed over the rear electrode wherein the phosphor layer is superimposed on top of the dielectric layer and the substrate layer is superimposed upon the phosphorous layer.

Preferably the at least two electrodes activate devices include a driving circuit adapted to supply a current to the electroluminescent lamp.

### BRIEF DESCRIPTION OF THE DRAWINGS

The present invention will now be described by way of example only and with reference to the accompanying drawings in which:

FIG. 1 illustrates a perspective view, exploded apart, of the parts forming a combined electroluminescent device and membrane switch unit according to the invention;

FIG. 2 illustrates a cross section of an electroluminescent device Section shown in FIG. 1;

FIG. 3 illustrates in detail a cross section through a spacer layer for the combined unit shown in FIG. 1;

FIG. 4 illustrates in detail a cross-section of a circuit layer for the combined unit shown in FIG. 1; and

FIG. 5 illustrates a cross-section of a complete electroluminescent membrane switch unit according to the invention.

The electroluminescent device part of the combined unit will hereinafter be referred to as an EL device for brevity.

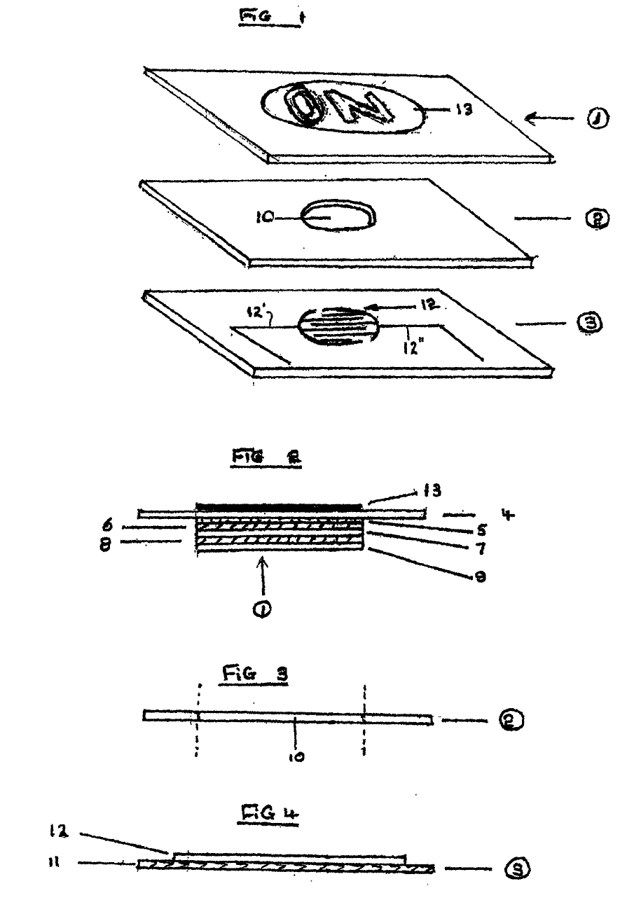

Shown in FIG. 1 is a perspective view of the exploded apart parts forming a combined EL device and membrane switch unit.

The EL device section is indicated as 1 and has a flexible polyester substrate 4 that has several layers of differing chemical components screenprinted thereon in a defined order of application.

FIG. 2 illustrates a cross-section of the EL device 1. The flexible polyester substrate 4 can be supplied by a manufacturer with a precoated idium tinoxide film, which is not indicated on FIG. 2.

In the EL device 1, a phosphor layer 5, dielectric layer 6 and silver back electrode layer 7 represent the components required to build the EL device section. These are printed on the conductive side of the substrate 4. An additional insulating dielectric 8 is sandwiched between the back electrode 7 and a shorting layer 9 which acts as a conducting shorting element of the membrane switch.

A switch face graphic 13 (FIG. 1) is printed on the opposite side of the substrate 4 so to create and nominate a switching function and indicate to a user where to push the switch for activation.

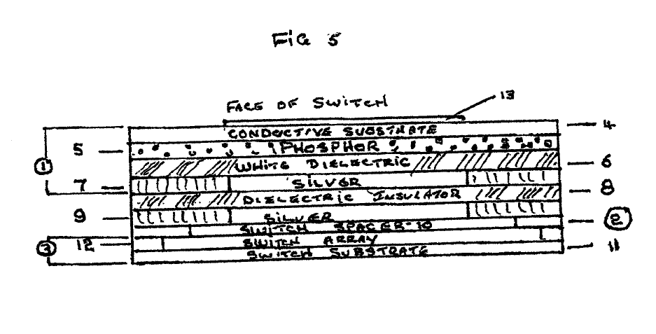

In FIG. 3 is shown a cross section view of a spacer element layer 2, which is superimposed over a membrane circuit layer 3. The spacer element layer 2 incorporates an aperture 10 so that the shorting layer 9 is accessible to a switch array 12.

In FIG. 4 is shown a cross section of the membrane circuit layer 3 which consists of a flexible non-conductive substrate 11 which has the conductive switch array 12 that forms the final element of the membrane switch. Track pairs 12′ and 12″ (FIG. 4) are shown and these form the switch array 12.

In FIG. 5 is shown a cross section of the complete electroluminescent membrane switch unit.

The unique feature of this device is that the face graphic 13 of the unit (the area pushed to operate it) is illuminated and due to the flexibility of the EL chemistry composition when downward force is applied to the graphic 13 of the EL device 1 it flexes downward moving the conductive shorting element 9 through the spacer element layer 2, aperture 10 into contact with the switch array 12.

This action shorts at least two of the track pairs 12′ and 12″ thus completing the switch circuit and closing the circuit attached thereto.

The array 12 is generally supported on a film or substrate layer 11. The tracks 12 may be formed by vacuum deposition of a metal or similar techniques which are known in the art.

The EL device 1 is driven by a high frequency AC circuit (not shown) and it is considered that construction of such a driver circuit is within the purview of one skilled in the art.

The components of the EL device are in the form of relatively thin films and are flexible to the extent that when a user presses down on the printed substrate, force is transmitted through the phosphor layer and the dielectric layer thereby bringing the rear electrode into contact with the electrode array thereby completing the circuit and closing the switch. The switch closure can not only be used to activate the desired switch function but also to activate a driving circuit which illuminates the EL device in response to the user's pressing thereupon.

Accordingly, a self illuminating lamp/membrane switch assembly is provided which is compact and may be manufactured in the form of a discrete unit having electrodes which may be easily connected to external switching and driving circuitry.

While the particular example shows an “ON” switch with a single membrane switch included, it is considered within the scope of the present invention that arrays of switches, such as those found in cash registers, computers and the like may be manufactured according to the present invention.

Further the present invention may be suitably adapted to artistic or advertising arrays whereby a user may press particular areas of such a printed array whereupon a shape or pattern is illuminated in response to the user's action.

The printed substrate is typically composed of a polyester sheet which acts as the upper capacitor plate when the EL device is energised. The phosphor layer is composed of materials which are commercially available and known in the art. Their particular selection will depend on the colour of the light to be emitted and the manufacturing conditions under which the switch/lamp is to be produced.

The dielectrics may be composed of barium titanate in combination with binder resins as are known in the art, The rear electrode, in this example, is composed of a silver layer thus providing particularly good conductive qualities. However, similar metals or materials may be substituted if required.

The track array 12, in this example, may be vacuum deposited or printed upon the supporting substrate.

It is also envisaged that the membrane switch may incorporate a tactile feedback means such as a clicking element which provides the user with tactile and/or audible feed back in combination with the visual feedback of the lamp being illuminated upon activating the membrane switch.

The present invention is particularly suitable for use in mass lamination manufacturing techniques. The various electrode connections may be traced to the edge of a planar EL lamp array to a standard type of connector which may be attached to appropriate driving and switching circuitry. The present invention thus provides a combination EL lamp/membrane switch assembly which can be manufactured relatively cheaply and easily, and further provides particularly useful functionality in applications where a thin, self illuminating switch assembly is required.

It is envisaged that such applications may include photocopiers, cash registers, car panels and instrument control arrays such as those found in oscilloscopes and similar devices.

It is further envisaged that the self-illuminating switches may find particular applications in environments where carefully controlled lighting characteristics are required, such as on aircraft flight decks or on car instrument panels. In these situations, the user is provided with positive visual feedback corresponding to the actuation of the switch and its associated function.

Where in the foregoing description reference has been made to elements or integers having known equivalents, then such integers are included as it they were individually set forth.

Although the present invention has been described with reference of an example and an embodiment thereof, it is envisaged that variations and modifications may be made thereto without departing from the scope of the appended claims.

1. An electroluminescent device and membrane switch including:
one or more electroluminescent lamp assemblies and one or more membrane switch assemblies, wherein a rear flexible electrode of the electroluminescent lamp(s) and a conductive layer of the membrane switch are superimposed on opposite sides of the same element(s) which function as the means by which the membrane switch(es) is/are closed upon actuation by a user.

2. An the electroluminescent lamp/membrane switch assembly comprises:
a membrane switch including:
at least two electrodes arranged so that upon bringing a flexible conductive layer in contact with said electrodes, the electrodes are shorted;
a flexible conductive layer covering at least two of the electrodes;
a spacer interposed between the conductive layer and the at least two electrodes, the spacer being adapted to hold the conductive layer away from the at least two electrodes while allowing the conductive layer to come into contact with the at least two electrodes upon the application of pressure by a user;
an electroluminescent lamp comprising:
a rear electrode;
a substrate layer juxtaposed over the rear electrode wherein a phosphor layer and dielectric layer are interposed between the rear electrode and a substrate layer;
wherein the rear electrode of the electroluminescent lamp and the conductive layer of the membrane switch superimposed on opposite sides of the same element.

3. An electroluminescent lamp/membrane switch assembly as claimed in claim 2 wherein the at least two electrodes are in the form of a conductive array deposited on a switch substrate layer wherein the conductive array is adapted so that when the conductive layer is pressed thereupon, the at least two electrodes are shorted.

4. An electroluminescent lamp/membrane switch assembly as claimed in claim 3 wherein the at least two electrodes are in the form of an array of intermeshed tracks formed on the switching substrate.

5. An electroluminescent lamp/membrane switch assembly as claimed in claim 2 wherein the dielectric layer is superimposed over the rear electrode wherein the phosphor layer is superimposed on top of the dielectric layer and the substrate layer is superimposed upon the phosphorous layer.

6. An electroluminescent lamp/membrane switch assembly as claimed in claim 3 wherein the dielectric layer is superimposed over the rear electrode wherein the phosphor layer is superimposed on top of the dielectric layer and the substrate layer is superimposed upon the phosphorous layer.

7. An electroluminescent lamp/membrane switch assembly as claimed in claim 4 wherein the dielectric layer is superimposed over The rear electrode wherein the phosphor layer is superimposed on top of the dielectric layer and the substrate layer is superimposed upon the phosphorous layer.

8. An electroluminescent lamp/membrane switch assembly as claimed in claim 2 wherein the at least two electrodes activate devices including a driving circuit adapted to supply a current to the assembly.
